(19) United States
(12) Patent Application Publication
(10) Pub. No.: US 2017/0150405 A1
(43) Pub. Date: May 25, 2017

(54) METHOD AND APPARATUS

(71) Applicant: Nokia Solutions and Networks Oy, Espoo (FI)

(72) Inventors: Tsunehiko Chiba, Saitama (JP); Srinivasan Selvaganapathy, Bangalore (IN); Benoist Pierre Sebire, Tokyo (JP)

(21) Appl. No.: 15/318,447

(22) PCT Filed: Jul. 3, 2014
(86) PCT No.: PCT/EP2014/064150

§ 371 Date: Dec. 13, 2016

(51) Int. Cl. H04W 36/00; H04L 29/06; H04W 12/04

(52) U.S. Cl. CPC H04W 36/0038; H04W 12/04; H04L 63/068

(57) ABSTRACT

A method comprises causing a first key to be used for communications between a first base station and a user device, said user device also being in communication with a second base station, causing first information, which indicates that an updated key is to be used, to be sent from the first base station to said user equipment, and causing said updated key to be used for communications between said first base station and said user device after said information has been sent.

Some embodiments relate to a method and apparatus and in particular but not exclusively to a method and apparatus for use in scenarios where a user device or equipment is in communication with two or more nodes or base stations.

A communication system can be seen as a facility that enables communication sessions between two or more nodes such as fixed or mobile communication devices, access points such as nodes, base stations, servers, hosts, machine type servers, routers, and so on. A communication system and compatible communicating devices typically operate in accordance with a given standard or specification which sets out what the various entities associated with the system are permitted to do and how that should be achieved. For example, the standards, specifications and related protocols can define the manner how communication devices shall communicate with the access points, how various aspects of the communications shall be implemented and how the devices and functionalities thereof shall be configured.

It should be understood that conveying, broadcasting, signalling, transmitting and/or receiving may herein mean preparing a data conveyance, broadcast, transmission and/or reception, preparing a message to be conveyed, broadcasted, signalled, transmitted and/or received, or physical transmission and/or reception itself, etc. on a case by case basis. The same principle may be applied to the terms transmission and reception as well.

A user can access the communication system by means of an appropriate communication device. A communication device of a user is often referred to as user equipment (UE), user device or terminal.

Signals can be carried on wired or wireless carriers. Examples of wireless systems include public land mobile networks (PLMN), satellite based communication systems and different wireless local networks, for example wireless local area networks (WLAN). Wireless systems can be divided into coverage areas referred to as cells, such systems being often referred to as cellular systems. A cell can be provided by a base station, there being various different types of base stations. Different types of cells can provide different features. For example, cells can have different shapes, sizes, functionalities and other characteristics. A cell is typically controlled by a control node.

A communication device is provided with an appropriate signal receiving and transmitting arrangement for enabling communications with other parties. In wireless systems a communication device typically provides a transceiver station that can communicate with another communication device such as e.g. a base station and/or another user equipment. A communication device such as a user equipment (UE) may access a carrier provided by a base station, and transmit and/or receive on the carrier.

An example of cellular communication systems is an architecture that is being standardized by the 3rd Generation Partnership Project (3GPP). A recent development in this field is often referred to as the long-term evolution (LTE) or long-term evolution advanced (LTE advanced) of the Universal Mobile Telecommunications System (UMTS) radio-access technology. In LTE base stations providing the cells are commonly referred to as enhanced NodeBs (eNB). An eNB can provide coverage for an entire cell or similar radio service area.

Cells can provide different service areas. For example, some cells may provide wide coverage areas while some other cells provide smaller coverage areas. The smaller radio coverage areas can be located wholly or partially within a larger radio coverage area. For example, in LTE a node providing cell(s) with a relatively wide coverage area is referred to as a macro eNode B. Examples of nodes providing smaller cells, or local radio service areas, include femto nodes such as Home eNBs (HeNB), pico nodes such as pico eNodeBs (pico-eNB) and remote radio heads.

A device may communicate with more than one cell. Communications with more than one cell may be provided e.g. to increase performance. Dual connectivity may be provided where a user device is configured to communicate both with two different eNBs: a master eNB (MeNB) and a secondary eNB (SeNB).

According to an aspect, there is provided a method comprising: causing a first key to be used for communications between a first base station and a user device, said user device also being in communication with a second base station; causing first information, which indicates that an updated key is to be used, to be sent from the first base station to said user equipment; and causing said updated key to be used for communications between said first base station and said user device after said information has been sent.

The method may comprise causing said first information to be sent from the first base station to said user equipment in a control channel.

The method may comprise causing said first information to be sent to said second base station from said first base station.

The method may comprise receiving a key modification message from the second base station and causing said first information to be sent to said second base station in response to said message.

The method may comprise causing said first information to be sent from said first base station to user device in response to receiving second information indicating that reconfiguration has been completed.

The method may comprise receiving said second information that said reconfiguration is complete from said second base station.

According to another aspect, there is provided a method comprising: causing a first key to be used for communications between a first base station and a user device, said user device also being in communication with a second base station; receiving first information, which indicates that an updated key is to be used, from the first base station at said user equipment; and causing said updated key to be used for communications between said first base station and said user device after said first information has been sent.

The method may comprise causing said first information to be received from the first base station in a control channel. The control channel may be a packet data control channel.

The method may comprise, prior to receiving said first information from said first base station, receiving said first information from said second base station.

The method may comprise using said first information or third information to control communications between said first base station and said user equipment, said first information indicating that said updated key is to be used and said third information indicating that said first key is to be used. The third information may be the information used prior to the first information.

According to another aspect, there is provided a method comprising: determining in a second base station that a first key used for communications between a first base station and a user device is to change, said user device also being in communication with a second base station; receiving first information, which indicates that an updated key is to be used, from the first base station at said second base station; and causing said first information to be provided to said user device.

The first information mentioned previously may comprise a cell radio network temporary identifier.

According to another aspect, there is provided an apparatus for use in a first base station comprising: means for causing a first key to be used for communications between said first base station and a user device, said user device also being in communication with a second base station; means for causing first information, which indicates that an updated key is to be used, to be sent to said user equipment; and means for causing said updated key to be used for communications between said first base station and said user device after said information has been sent.

The causing means may be for causing said first information to be sent to said user equipment in a control channel.

The apparatus may comprise means for causing said first information to be sent to said second base station.

The apparatus may comprise means for receiving a key modification message from the second base station and said means for causing said first information to be sent to said second base station may be responsive to said message.

The causing means for causing said first information to be sent to user device may be responsive to receiving second information indicating that reconfiguration has been completed.

The apparatus may comprise means for receiving said second information that said reconfiguration has been completed from said second base station.

According to another aspect, there is provided an apparatus for use in a user device comprising: means for causing a first key to be used for communications between a first base station and said user device, said user device also being in communication with a second base station; means for receiving first information, which indicates that an updated key is to be used, from the first base station; and means for causing said updated key to be used for communications between said first base station and said user device after said first information has been sent.

The first information may be received from the first base station in a control channel. The control channel may be a packet data control channel.

The apparatus may comprise, means for receiving said first information from said second base station, prior to receiving said first information from said first base station.

The apparatus may comprise means for using said first information or third information to control communications between said first base station and said user equipment, said first information indicating that said updated key is to be used and said third information indicating that said first key is to be used. The third information may be the information used prior to the first information.

According to another aspect, there is provided an apparatus for use in a second base station, said apparatus comprising: means for determining that a first key used for communications between a first base station and a user device is to change, said user device also being in communication with a second base station; means for receiving first information, which indicates that an updated key is to be used, from the first base station at said second base station; and means for causing said first information to be provided to said user device.

The first information mentioned previously may comprise a cell radio network temporary identifier.

According to another aspect, there is provided an apparatus for use in a first base station, said apparatus comprising at least one processor and at least one memory including computer code for one or more programs, the at least one memory and the computer code configured, with the at least one processor, to cause the apparatus at least to: cause a first key to be used for communications between said first base station and a user device, said user device also being in communication with a second base station; cause first information, which indicates that an updated key is to be used, to be sent to said user equipment; and cause said updated key to be used for communications between said first base station and said user device after said information has been sent.

The at least one memory and the computer code may be configured, with the at least one processor, to cause said first information to be sent to said user equipment in a control channel.

The at least one memory and the computer code may be configured, with the at least one processor, to cause said first information to be sent to said second base station.

The at least one memory and the computer code may be configured, with the at least one processor, to receive a key modification message from the second base station and cause said first information to be sent to said second base station responsive to said message.

The at least one memory and the computer code may be configured, with the at least one processor, to cause said first information to be sent to user device responsive to receiving second information indicating that reconfiguration has been completed.

The at least one memory and the computer code may be configured, with the at least one processor, to receive said second information that said reconfiguration has been completed from said second base station.

According to another aspect, there is provided an apparatus for use in a user equipment, said apparatus comprising at least one processor and at least one memory including computer code for one or more programs, the at least one memory and the computer code configured, with the at least one processor, to cause the apparatus at least to: cause a first key to be used for communications between a first base station and said user device, said user device also being in communication with a second base station; receive first information, which indicates that an updated key is to be used, from the first base station; and cause said updated key to be used for communications between said first base station and said user device after said first information has been sent.

The first information may be received from the first base station in a control channel. The control channel may be a packet data control channel.

The at least one memory and the computer code may be configured, with the at least one processor, to receive said first information from said second base station, prior to receiving said first information from said first base station.

The at least one memory and the computer code may be configured, with the at least one processor, to use said first information or third information to control communications between said first base station and said user equipment, said first information indicating that said updated key is to be used and said third information indicating that said first key is to be used. The third information may be the information used prior to the first information.

According to another aspect, there is provided an apparatus for use in a second base station, said apparatus comprising at least one processor and at least one memory including computer code for one or more programs, the at least one memory and the computer code configured, with the at least one processor, to cause the apparatus at least to: determine that a first key used for communications between a first base station and a user device is to change, said user device also being in communication with a second base station; receive first information, which indicates that an updated key is to be used, from the first base station at said second base station; and cause said first information to be provided to said user device.

The first information mentioned previously may comprise a cell radio network temporary identifier.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

Some embodiments will now be described, by way of example only, with respect to the following Figures in which:

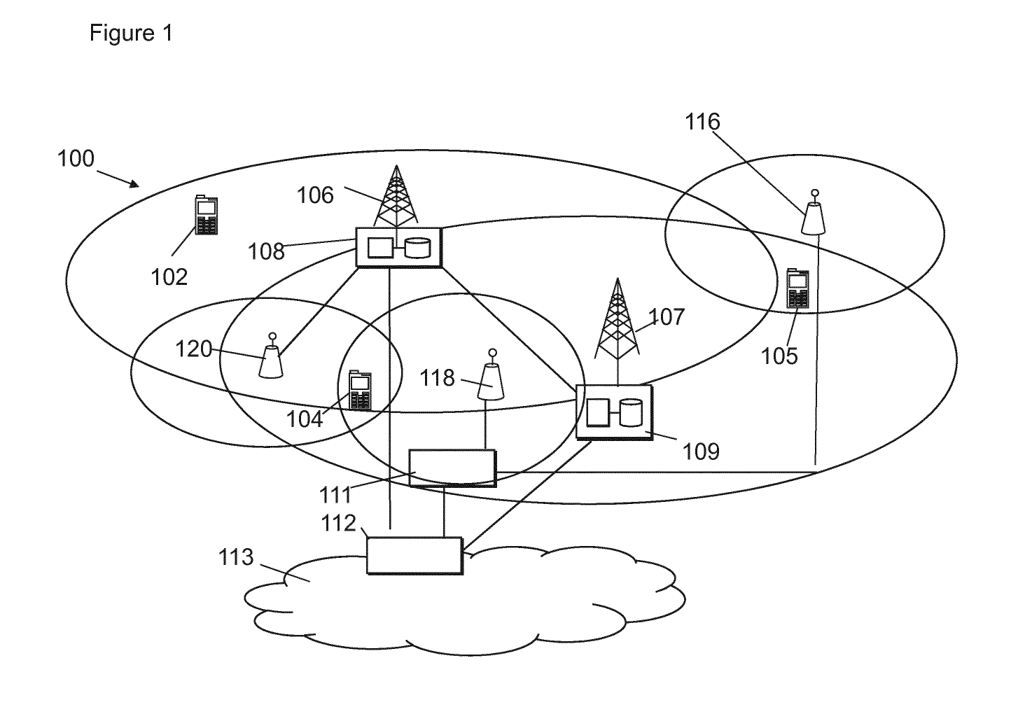

FIG. 1 shows a schematic diagram of a network according to some embodiments;

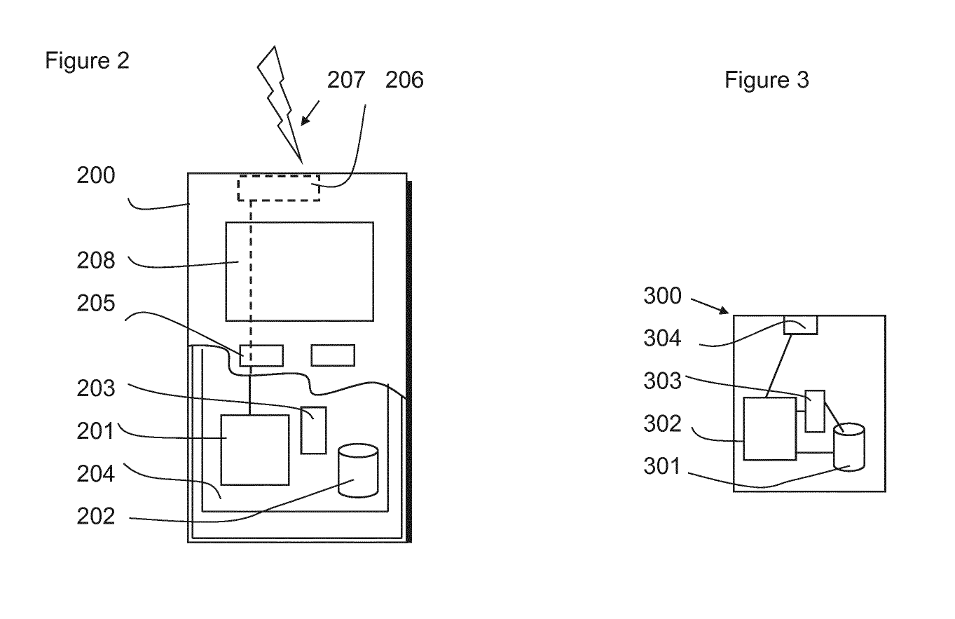

FIG. 2 shows a schematic diagram of a mobile communication device according to some embodiments;

FIG. 3 shows a schematic diagram of a control apparatus according to some embodiments;

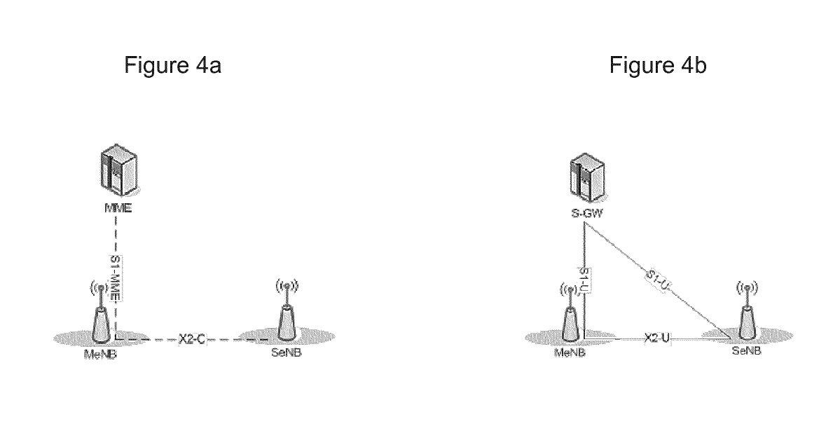

FIGS. 4a and 4b respectively show control plane and user plane connectivity in dual connectivity;

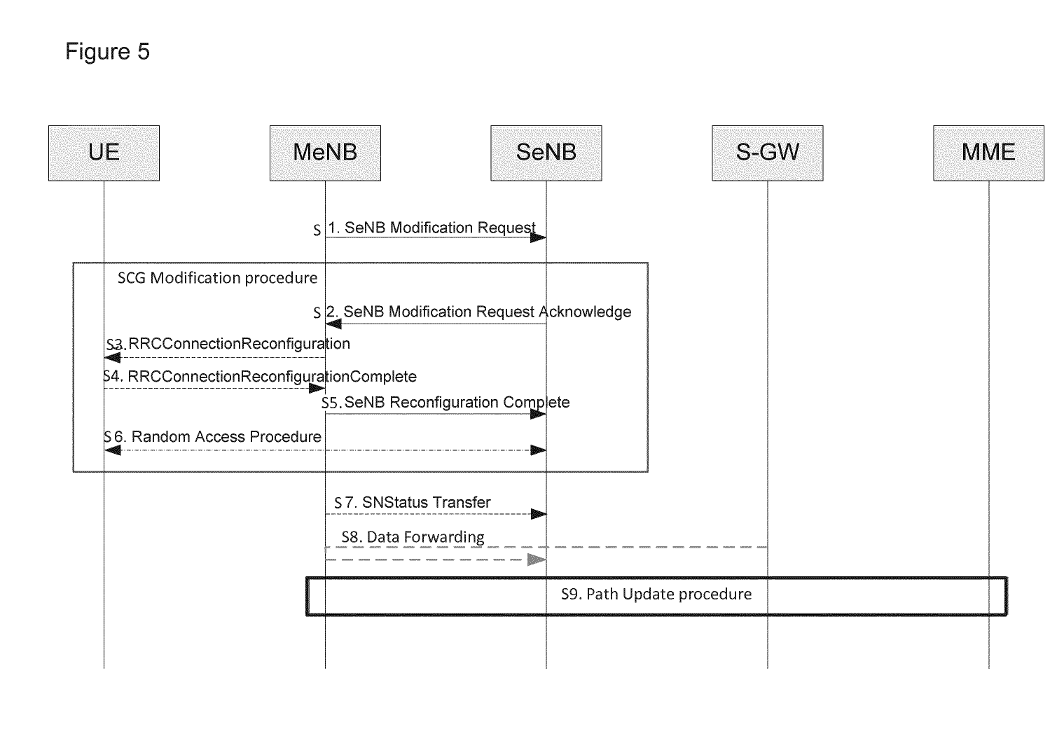

FIG. 5 shows a first signal flow for modifying a SeNB; and

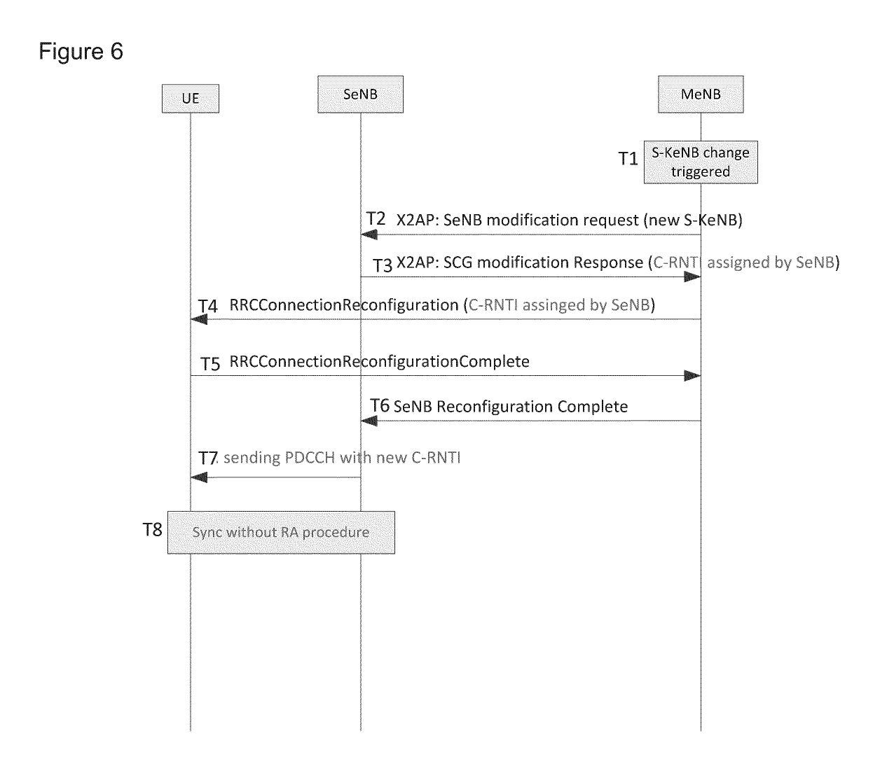

FIG. 6 shows a second signal flow for key refresh.

Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipment (UE) 102, 103, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively).

In FIG. 1 base stations 106 and 107 are shown as connected to a wider communications network 113 via gateway 112. A further gateway function may be provided to connect to another network. These may be macro base stations. The smaller base stations 116, 118 and 120 may also be connected to the network 113, for example by a separate gateway function and/or via the controllers of the macro level stations. In the example, stations 116 and 118 are connected via a gateway 111 whilst station 120 connects via the controller apparatus 108. In some embodiments, the smaller stations may not be provided. The smaller base stations may provide a femto cell, a pico cell, a micro cell, and/or the like.

A possible communication device will now be described in more detail with reference to FIG. 2 showing a schematic, partially sectioned view of a communication device 102. Such a communication device is often referred to as user equipment (UE) or terminal. An appropriate communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like.

The device 102 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the device.

A device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the device by means of a suitable user interface such as key pad 205, voice commands, touch sensitive screen or pad, combinations thereof or the like. A display 208, a speaker and a microphone can be also provided. Furthermore, a communication device may comprise appropriate connectors (either wired or wireless) to other devices and/or for connecting external accessories, for example hands-free equipment, thereto. Some apparatus of the device may be configured to cause the performance of one or more of the signal flow steps as described later.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs). Other examples of radio access system include those provided by base stations of systems that are based on technologies such as wireless local area network (WLAN) and/or WiMax (Worldwide Interoperability for Microwave Access).

FIG. 3 shows an example of a control apparatus 300. This control apparatus may be provided in one or more of a base station, a MME or any other suitable entity. The control apparatus can be configured to provide control functions. For this purpose the control apparatus comprises at least one memory 301, at least one data processing unit 302, 303 and an input/output interface 304. Via the interface the control apparatus can be coupled to receive and/or provide data. The control apparatus 114 can be configured to execute an appropriate software code to provide the control functions. The control apparatus may be provided in a MeNB and/or a SeNB. The apparatus may be configured to cause the performance of one or more of the signal flow steps as described later.

Base stations may communicate with each other via a fixed line connection and/or air interface.

A user device or user equipment UE may communicate with more than one cell. Communications with more than one cell may be provided e.g. to increase performance. Dual connectivity may be provided where a user device is configured to communicate with two base stations, for example, with both with a master eNB (MeNB) and a secondary eNB (SeNB). This mode of operation may be known as dual connectivity i.e. when a UE is configured with a Master Cell Group (MCG) and a Secondary Cell Group (SCG) respectfully managed by the MeNB and SeNB. It may be possible to communicate with more than two base stations. It may also be possible to have more than one secondary cell group.

Reference is made to FIG. 4. FIGS. 4a and 4b respectively show the C-Plane (control plane) and U-Plane (user plane) connectivity of eNBs in dual connectivity.

Reference is made to FIG. 4a. As shown in this Figure, there is a control connection between the MeNB and the MME (mobility management entity) via a S1-MME connection. There is an X2 connection between the MeNB and the SeNB.

In dual connectivity, there may be three types of bearer as will now be described with reference to FIG. 4b.

For MCG bearers, the MeNB is U-plane connected to the S-GW (serving gateway) via S1-U, the SeNB is not involved in the transport of user plane data. In the case of FIG. 4b, there would be no S1-U connection between the SeNB and the S-GW and no X2-U connection with the SeNB.

For split bearers, the MeNB is U-plane connected to the S-GW via the S1-U connection and in addition, the MeNB and the SeNB are interconnected via X2-U. The SeNB is not connected to the S-GW.

For SCG bearers, the SeNB is directly connected with the S-GW via S1-U.

Keys related to security algorithms are used to protect the user-plane and control plane traffic (RRC signaling) between UE and eNB.

For control plane signaling ciphering and integrity protection is achieved using these keys and for user-plane, these keys are only used for ciphering of the data-packets.

In LTE, the base key used for security algorithm is received from EPC (core network) as part of initial context setup. This key is known as Kasme.

An eNB internally generates a key known as KeNB which is based on Kasme and also the PCl/ARFCN (physical cell identity/absolute radio frequency channel number) corresponding to the current-cell.

The KeNB changes whenever a UE moves across cells. When the UE moves from for example, cell-1 to cell-2 belonging to the same eNB, the new KeNB is generated based on the PCl/ARFCN values corresponds to cell-2 and the current KeNB value. This is known as horizontal key derivation.

In case if a UE moves across cells of different eNBs, the new KeNB is derived based on the above parameters along with some additional information from EPC called NH (next hop key).

The above is applicable to single connectivity cases. When the LTE or the like system supports dual connectivity some complexity may arise.

With dual connectivity, SCG bearers require ciphering to take place in the SeNB. Ciphering at SeNB is based on a key named S-KeNB. It is derived from the KeNB and a counter value (Small Cell Counter). The SCC changes whenever UE changes SeNB, so the S-KeNB also changes. In some embodiments, a key refresh used to avoid the same key being reused across multiple packets of same bearer traffic. When the base key is changed the generated keys needs to be changed.

It has been proposed that whenever the key (KeNB) is changed the bearer traffic is suspended and both UE and eNB synchronize the use of the new key after RACH (random access channel) Access. For this purpose, the intra-MeNB handover procedure is reused. The UE triggers RA (random access) on reception of RRC reconfiguration with mobility information and thus achieves the synchronization. Synchronization means use of the new key in uplink and downlink in a synchronized manner so that both sides know from when the new key is to be applied.

Thus, it may be necessary to perform a key update/refresh for intra-MeNB handover (moving between cells of the same MeNB) and/or S-eNB key (S-KeNB) refresh. One example of a possible signal flow for SeNB key refresh is shown in FIG. 5.

In step S1 the MeNB sends a SeNB modification request to the SeNB.

In step S2, the SeNB will send an acknowledgment of the SeNB modification request to the MeNB.

In step S3, the MeNB sends a RRC connection reconfiguration message to the UE.

In step S4, the UE sends a RRC connection reconfiguration complete message to the MeNB.

In step S5, the MeNB sends a SeNB reconfiguration complete message to the SeNB.

In step S6, a random access procedure RA is carried out between the UE and the SeNB.

Steps S2 to S6 may be regarded as the being the SCG modification procedure.

In step S7, the MeNB send a SN status transfer message to the SeNB.

In step S8, data is forwarded from the MeNB to the SeNB and the S-GW.

In step S9, a path update procedure is completed between the MeNB and the MME.

In some embodiments, one RRC message may be used for SCG release/addition for S-KeNB refresh and/or intra MeNB handover as below.

The key refresh procedure may address the key refresh due to the change of KeNB (either initiated by MME or MeNB locally) and S-KeNB refresh initiated by the SeNB.

There may be one RRC message for SCG release/addition that can be used to refresh the S-KeNB (as part of RRC connection reconfiguration and/or used as part of intra-MeNB handover (as part of RRC connection reconfiguration with mobility control information involving KeNB refresh and S-KeNB refresh)

The SCG addition process may imply provisioning of a new S-KeNB.

The UE does not need to distinguish intra- and inter-eNB handover, as the same mechanism is used for both.

With SCG modification, the S-KeNB change would happen with a random access (RA) procedure.

For example, the SCG modification procedure is initiated by the SeNB and used to perform configuration changes of the SCG within the same SeNB. The SeNB requests SCG modification by providing the new radio resource configuration of SCG by an inter eNB RRC message carried by an appropriate X2 message between the SeNB and the MeNB. If the MeNB accepts the SeNB request, the MeNB sends the RRC connection reconfiguration message to the UE including the new radio resource configuration of SCG according to the Inter eNB RRC message. The UE applies the new configuration and replies with the RRC connection reconfiguration complete message. If synchronisation towards the SeNB is not required for the new configuration, the UE may perform UL transmission after having applied the new configuration. If the new configuration requires synchronisation towards the SeNB, the UE performs the Random Access procedure.

Some embodiments provide a method which may avoid a RA (Random Access) procedure for intra-MeNB handover and/or S-KeNB change procedures so that UE and SeNB can apply the new key and start sending/receiving as soon as possible. Some embodiments may provide a key refresh mechanism with synchronization achieved without RA. Here both the UE and SeNB know the use of the new key based on the new C-RNTI allocated.

It should be appreciated that in some embodiments there may be a number of reasons why the S-KeNB needs to refresh. This may be because, the KeNB (of the MeNB) has changed, the Kasme key has changed and/or a refresh needed due to long time use of same key for bearers.

As described above, when one RRC message is used for SCG release and in addition for S-KeNB refresh and intra-MeNB handover, RA is performed to apply the new key configuration. This will cause the delay for SeNB and UE to start sending and receiving data. Some embodiments may use a new C-RNTI to identify that a new S-KeNB is used.

A method of an embodiment will now be described with reference to FIG. 6. The method shown in FIG. 6 provides an S-KeNB change procedure so that UE and SeNB can apply a new key and start sending/receiving as soon as possible. The S-KeNB change may be required for any one or more of the reasons discussed earlier. This may be because, the KeNB (of the MeNB) has changed, the Kasme key has changed and/or a refresh needed due to long time use of same key for bearers. The KeNB of the MeNB may change for a number of different reasons, such as intra MeNB handover.

In step T1, the MeNB detects a trigger for the S-KeNB change.

In step T2, once the MeNB has detected the trigger for an S-KeNB change, the MeNB sends a SeNB modification request with a new S-KeNB key to the SeNB.

In step T3, the SeNB replies to the MeNB with a SeNB modification response which has a new C-RNTI (cell radio network temporary identifier) assigned by the SeNB. The SeNB stops scheduling towards the UE with the old C-RNTI from this point. This is for both uplink and downlink. The SeNB also ensures that all pending retransmissions are completed and any possible SR (scheduling requests) ignored. The pending retransmission refers here to the Hybrid ARQ retransmissions. It is not possible for the eNB to assign the old C-RNTI to any other UE before completing the procedure.

In step T4 the MeNB sends a RRC connection reconfiguration message to the UE with the configuration received from the SeNB. This has the C-RNTI.

In step T5, on reception of new C-RNTI and new value for SCC, the UE stops its uplink data transmission after completion of any pending Hybrid ARQ retransmissions and the UE replies with a RRC connection reconfiguration complete message to the MeNB. In step T6, the MeNB forwards the received information from the UE to the SeNB.

In step T7, the SeNB resumes scheduling towards the UE using the new C-RNTI on its PDCCH (packet data control channel) when the SeNB receives the SeNB reconfiguration complete message indicating that the UE has received the new configuration and applied it. Even if there is no downlink data to be transferred at this moment, the SeNB sends a Physical Downlink Control Channel (PDCCH) with uplink allocation. This is because the PDCCH with new C-RNTI is needed to resume the uplink data transmission from the UE.

As indicated by step T8, on reception of the PDCCH with new C-RNTI the UE starts its uplink transmission. On reception of the PDCCH with the new C-RNTI, the UE knows that the new S-KeNB needs to be used to decipher downlink Packet Data Convergence Protocol (PDCP) Protocol Data Units (PDUs) and to cipher uplink PDCP Service Data Units (SDUs).

The synchronisation is thus achieved without a random access procedure. At the UE-side, the reception of the PDCCH with a new C-RNTI after sending the RRC connection reconfiguration complete message is the starting point for synchronisation. At the SeNB side the reception of the RRC connection reconfiguration complete message and the sending of PDCCH with new C-RNTI are used as the indication of use of a new key instead of RA based synchronisation.

In another embodiment, two C-RNTI may be used in parallel during the transient period to minimise service interruption. The old C-RNTI indicates in downlink that the old key needs to be used for deciphering and that in uplink the old key needs to be used for ciphering. The new C-RNTI indicates in downlink that the new key needs to be used for deciphering and in uplink that the new key needs to be used for ciphering. In other words, the presence of the CRNTI value will indicate if the new or old key is to be used.

In case the reset of MAC (media access control), Radio Link Control (RLC) and PDCP is needed as part of the S-KeNB change due to the impact on pending RLC or PDCP transmissions, the method described above may be modified to additionally or alternatively perform the following steps. The UE resets its L2 layers and re-establishes the L2 layer on reception of new C-RNTI along with new SCC value. The SeNB also resets its L2 layers and re-establishes the L2 layers on reception of SeNB reconfiguration complete message for the S-KeNB change operation. The steps may take place at the same time or in either order. In this case the UE stores the timing advance information including the timing advance value and the timing advance (TA) remaining timeout so that there is no need for additional RACH-Access to perform uplink synchronisation.

If the S-KeNB key refresh is triggered due to a K-eNB change, the method can be combined with the intra-MeNB handover by for example making one or more of the following modifications to the method:

The MeNB sends the RRC connection reconfiguration message containing mobility-information along with new C-RNTI value and new SCC value to UE.

On reception of the RRC connection reconfiguration message with the mobility-information and the new S-KeNB configuration, the UE sends the RRC connection reconfiguration complete to the MeNB after contention free Random Access Channel (RACH) access. The UE also deactivates all its SCells including the SCG cells before sending the RRC connection reconfiguration complete message.

On sending the RRC connection reconfiguration complete message, the UE activates PSCell (special SCell at SeNB) of the SCG with the new S-KeNB values and re-establishes its L2 layers. UE continue to use the same TA value after reset also to avoid need of RA for obtaining the new TA value. At this point the UE waits for the SeNB to send the new C-RNTI in PDCCH to start the uplink activity.

On reception of RRC connection reconfiguration complete, the MeNB sends the SeNB reconfiguration complete message to the SeNB and the behaviour of the SeNB is same as mentioned previously.

An appropriately adapted computer program code product or products may be used for implementing the embodiments, when loaded on an appropriate data processing apparatus. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is also noted herein that while the above describes exemplifying embodiments of the invention, there are several variations and modifications which may be made to the disclosed solution without departing from the scope of the present invention.

1-25. (canceled)

26. An apparatus, comprising at least one processor and at least one memory including computer code for one or more programs, the at least one memory and the computer code configured, with the at least one processor, to cause the apparatus at least to:
cause a first key to be used for communications between a first base station and a user device, said user device also being in communication with a second base station;
receive first information, which indicates that an updated key is to be used, from the first base station; and
cause said updated key to be used for communications between said first base station and said user device after said first information has been sent.

27. The apparatus as claimed in claim 26, wherein the first information is received from the first base station in a control channel.

28. The apparatus as claimed in claim 26, wherein the at least one memory and the computer code are configured, with the at least one processor, to receive said first information from said second base station, prior to receiving said first information from said first base station.

29. The apparatus as claimed in claim 26, wherein the at least one memory and the computer code are configured, with the at least one processor, to use said first information or third information to control communications between said first base station and said user equipment, said first information indicating that said updated key is to be used and said third information indicating that said first key is to be used.

30. The apparatus as claimed in claim 26, wherein the first information comprises a cell radio network temporary identifier.

31. An apparatus, comprising at least one processor and at least one memory including computer code for one or more programs, the at least one memory and the computer code configured, with the at least one processor, to cause the apparatus at least to:
cause a first key to be used for communications between a first base station and a user device, said user device also being in communication with a second base station;
cause first information, which indicates that an updated key is to be used, to be sent to said user device; and
cause said updated key to be used for communications between said first base station and said user device after said information has been sent.

32. The apparatus as claimed in claim 31, wherein the at least one memory and the computer code are configured, with the at least one processor, to cause said first information to be sent to said user device in a control channel.

33. The apparatus as claimed in claim 31, wherein the at least one memory and the computer code are configured, with the at least one processor, to cause said first information to be sent to said second base station.

34. The apparatus as claimed in claim 33, wherein the at least one memory and the computer code are configured, with the at least one processor, to receive a key modification message from the second base station and cause said first information to be sent to said second base station responsive to said message.

35. The apparatus as claimed in claim 31, wherein the at least one memory and the computer code are configured, with the at least one processor, to cause said first information to be sent to user device responsive to receiving second information indicating that reconfiguration has been completed.

36. The apparatus as claimed in claim 35, wherein the at least one memory and the computer code are configured, with the at least one processor, to receive said second information that said reconfiguration has been completed from said second base station.

37. The apparatus as claimed in claim 31, wherein the first information comprises a cell radio network temporary identifier.

38. An apparatus, comprising at least one processor and at least one memory including computer code for one or more programs, the at least one memory and the computer code configured, with the at least one processor, to cause the apparatus at least to:
determine that a first key used for communications between a first base station and a user device is to change, said user device also being in communication with a second base station;
receive first information, which indicates that an updated key is to be used, from the first base station at said second base station; and
cause said first information to be provided to said user device.

39. The apparatus as claimed in claim 38, wherein the first information comprises a cell radio network temporary identifier.

40. The apparatus as claimed in claim 38, wherein the at least one memory and the computer code are configured, with the at least one processor, to send said first information to said user device in a control channel.

41. The apparatus as claimed in claim 38, wherein the at least one memory and the computer code are configured, with the at least one processor, to receive the first information from the first base station.
